(19) United States
(12) Patent Application Publication
(10) Pub. No.: US 2024/0304807 A1
(43) Pub. Date: Sep. 12, 2024

(54) POSITIVE ELECTRODE LEAD PASTE FOR LONG-LIFE SILICON-BASED BIPOLAR LEAD BATTERY AND PREPARATION METHOD THEREOF

(71) Applicant: ANHUI LEOCH POWER SUPPLY CORP, Huaibei (CN)

(72) Inventors: Shuxiang ZHANG, Huaibei (CN); Jianghong DOU, Huaibei (CN); Nawa HOU, Huaibei (CN); Bo ZHANG, Huaibei (CN)

(73) Assignee: ANHUI LEOCH POWER SUPPLY CORP, Huaibei (CN)

(21) Appl. No.: 18/270,882

(22) PCT Filed: Dec. 28, 2020
(86) PCT No.: PCT/CN2020/139960

§ 371 Date: Jul. 5, 2023

(30) Foreign Application Priority Data
Aug. 21, 2020 (CN) 202010847834.1

(51) Int. Cl. H01M 4/57; H01M 4/02; H01M 4/20; H01M 10/18

(52) U.S. Cl. CPC H01M 4/57; H01M 4/20; H01M 10/18; H01M 2004/021; H01M 2004/029

(57) ABSTRACT

A positive electrode lead paste for a long-life silicon-based bipolar lead battery and a preparation method thereof are disclosed. The positive electrode lead paste includes a lead powder, a short fiber, a graphite powder, SnSO₄, Ti₄O₇, Sb₂O₃, 4PbO·PbSO₄, sodium perborate, dilute sulfuric acid, and deionized water. The preparation method includes S1, adding a graphite powder, 4PbO·PbSO₄, SnSO₄, Ti₄O₇, Sb₂O₃, sodium perborate, and a short fiber to a lead powder, and dry-stirring for 5 min until the above materials are evenly mixed to obtain a premixture 1; S2, rapidly adding deionized water to the premixture 1, and thoroughly stirring for 10 min to obtain a premixture 2; and S3, slowly adding dilute sulfuric acid to the premixture 2 within 10 min, where a temperature of a resulting mixture is 70° C., and stirring the resulting mixture for 10 min; and cooling to 50° C., and controlling the apparent density at 4.45±0.1 g/cm³.

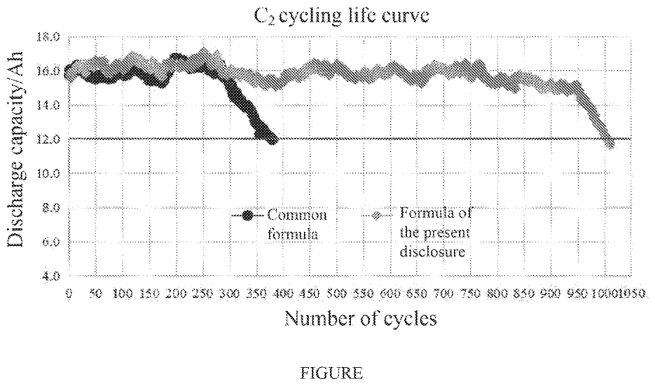

### CROSS REFERENCE TO THE RELATED APPLICATIONS

This application is the national phase entry of International Application No. PCT/CN2020/139960, filed on Dec. 28, 2020, which is based upon and claims priority to Chinese Patent Application No. 202010847834.1, filed on Aug. 21, 2020, the entire contents of which are incorporated herein by reference.

### TECHNICAL FIELD

The present disclosure belongs to the technical field of lead-acid batteries, and in particular relates to a positive electrode lead paste for a long-life silicon-based bipolar lead battery.

### BACKGROUND

With the increasingly fierce competition in the lead-acid battery industry, the increasingly high requirements of use terminals for batteries, and the impact of li-iron batteries on the battery industry, it requires battery manufacturers to continuously improve production processes and technologies, develop novel products, and control manufacturing costs. The weight reduction of grids and active materials thereof has become a key technology investigated by the global battery manufacturers, but due to the limitations of batteries themselves, this work is difficult to advance.

Currently, for maintenance-free valve-regulated batteries in the industry, lead-calcium alloys are generally used to make grids, but the lead-calcium alloys themselves have poor corrosion resistance. Therefore, it is necessary to find excellent alternative materials. Some manufacturers use lead-plated plastic grids to replace lead grids, but due to industrial manufacturing process defects and limited use intensities of the plastic grids themselves, the plastic grids can hardly be promoted in enterprises. In addition, it is difficult to find an alternative material with favorable cost performance.

When lead-acid batteries are cycled, the softening and shedding of positive electrode lead pastes is one of the main life attenuation modes. The softening and shedding are related to the end-use conditions, and a change of the crystallinity of lead paste can also lead to the softening, shedding, and deterioration of the lead paste. Therefore, how to postpone the softening and shedding of a positive electrode lead paste has become one of the key technologies to increase a cycling life of a battery.

### SUMMARY

In view of the shortcomings of the prior art, the present disclosure provides a positive electrode lead paste for a long-life silicon-based bipolar lead battery. Specific technical solutions are as follows:

A positive electrode lead paste for a long-life silicon-based bipolar lead battery is provided, where a formula of the positive electrode lead paste for a long-life silicon-based bipolar lead battery includes the following components: a lead powder, a short fiber, a graphite powder, SnSO₄, Ti₄O₇, Sb₂O₃, 4PbO·PbSO₄, sodium perborate, dilute sulfuric acid, and deionized water.

Further, the components in the formula of the positive electrode lead paste for a long-life silicon-based bipolar lead battery are used at amounts as follows: a weight of the short fiber is 0.5% to 1.5% of a weight of the lead powder; a weight of the graphite powder is 2% to 5% of the weight of the lead powder; a weight of the Sb₂O₃ is 0.03% to 0.1% of the weight of the lead powder; a weight of the 4PbO·PbSO₄ is 0.5% to 1.5% of the weight of the lead powder; a weight of the SnSO₄ is 0.03% to 0.1% of the weight of the lead powder; a weight of the Ti₄O₇ is 0.1% to 0.3% of the weight of the lead powder; a weight of the deionized water is 9% to 11% of the weight of the lead powder; a weight of the dilute sulfuric acid is 8% to 12% of the weight of the lead powder; a weight of the sodium perborate is 0.01% to 0.05% of the weight of the lead powder; and the lead powder accounts for the balance.

Further, the dilute sulfuric acid has a density of (1.325-1.400)±0.003 g/cm³.

Further, the lead powder has an oxidation degree of 72% to 80%, and in the lead powder, iron, manganese, copper, and chlorine contents each are lower than 5 ppm and a bismuth content is lower than 40 ppm.

Further, in the dilute sulfuric acid, an iron content is lower than 0.5 ppm and a chlorine content is lower than 5 ppm.

A preparation method of a positive electrode lead paste for a long-life silicon-based bipolar lead battery is provided, including the following steps:
S1, adding a graphite powder, 4PbO·PbSO₄, SnSO₄, Ti₄O₇, Sb₂O₃, sodium perborate, and a short fiber to a lead powder according to a formula ratio, and dry-stirring a resulting mixture for 4 min to 7 min until the above materials are evenly dispersed in the lead powder to obtain a premixture 1;
S2, rapidly adding deionized water to the premixture 1, and thoroughly stirring a resulting mixture for 8 min to 13 min to obtain a premixture 2; and
S3, slowly adding dilute sulfuric acid with a density of (1.325-1.400)±0.003 g/cm³ to the premixture 2 within 10 min to 15 min, and stirring a resulting mixture for 5 min to 10 min; and cooling to 50° C., measuring an apparent density, and controlling the apparent density at 4.45±0.1 g/cm³.

Further, in S3, the premixture 2 and the dilute sulfuric acid are mixed at a temperature controlled at 65° C. to 75° C.

Further, a weight ratio of the lead powder, the short fiber, the graphite powder, the SnSO₄, the Ti₄O₇, the Sb₂O₃, the 4PbO·PbSO₄, the sodium perborate, the dilute sulfuric acid, and the deionized water is as follows: a weight of the short fiber is 0.5% to 1.5% of a weight of the lead powder; a weight of the graphite powder is 2% to 5% of the weight of the lead powder; a weight of the Sb₂O₃ is 0.03% to 0.1% of the weight of the lead powder; a weight of the 4PbO·PbSO₄ is 0.5% to 1.5% of the weight of the lead powder; a weight of the SnSO₄ is 0.03% to 0.1% of the weight of the lead powder; a weight of the Ti₄O₇ is 0.1% to 0.3% of the weight of the lead powder; a weight of the deionized water is 9% to 11% of the weight of the lead powder; a weight of the dilute sulfuric acid is 8% to 12% of the weight of the lead powder; a weight of the sodium perborate is 0.01% to 0.05% of the weight of the lead powder; and the lead powder accounts for the balance.

Further, the lead powder has an oxidation degree of 72% to 80%; in the lead powder, iron, manganese, copper, and chlorine contents each are lower than 5 ppm and a bismuth content is lower than 40 ppm; and in the dilute sulfuric acid, an iron content is lower than 0.5 ppm and a chlorine content is lower than 5 ppm.

The present disclosure has the following beneficial effects:
1. Compared with the development of alternative grid materials, it is easy to improve a formula of a lead paste. The present disclosure improves a formula of a lead paste without changing the existing lead paste production process to achieve the high utilization and high performance of the lead paste, and the lead paste of the present disclosure can obviously exhibit its advantages when used in combination with a bipolar structure. The preparation method of the present disclosure is simple, easy to implement, and conducive to promotion.
2. The addition of SnSO₄, Ti₄O₇, Sb₂O₃, and sodium perborate can enhance the binding between the lead paste and an electrical conductor, effectively promote the tight binding among lead paste particles, significantly improve the conductivity of the lead paste, and effectively postpone the softening and shedding of the lead paste to extend a cycling life.
3. The mixing in S3 is conducted at 65° C. to 75° C., such that a sufficient amount of a highly-active substance can be produced during preparation of the lead paste, where the highly-active substance can improve a binding strength among lead paste particles.
4. The lead powder needs to have an oxidation degree of 72% to 80%, and in the lead powder, iron, manganese, copper, and chlorine contents each are lower than 5 ppm and a bismuth content is lower than 40 ppm. In the dilute sulfuric acid, an iron content is lower than 0.5 ppm and a chlorine content is lower than 5 ppm. The iron, manganese, copper, and chlorine contents of lower than 50 ppm and the bismuth content of lower than 100 ppm in the lead paste can effectively ensure a quality of the lead paste and prevent excessive impurities from affecting the compactness of the lead paste.

### BRIEF DESCRIPTION OF THE DRAWINGS

The FIGURE shows a C2 cycling life curve of the present disclosure.

### DETAILED DESCRIPTION OF THE EMBODIMENTS

To make the objective, technical solutions, and advantages of the present disclosure comprehensible, the present disclosure will be further described below in detail below with reference to examples. It should be understood that the specific examples described herein are merely intended to explain the present disclosure, rather than to limit the present disclosure.

### Example 1

A positive electrode lead paste for a long-life silicon-based bipolar lead battery was provided, where a formula of the positive electrode lead paste included the following components: a lead powder, a short fiber, a graphite powder, SnSO₄, Ti₄O₇, Sb₂O₃, 4PbO·PbSO₄, sodium perborate, dilute sulfuric acid, and deionized water, where a weight of the short fiber was 0.5% of a weight of the lead powder; a weight of the graphite powder was 2% of the weight of the lead powder; a weight of the Sb₂O₃ was 0.03% of the weight of the lead powder; a weight of the 4PbO·PbSO₄ was 0.5% of the weight of the lead powder; a weight of the SnSO₄ was 0.03% of the weight of the lead powder; a weight of the Ti₄O₇ was 0.1% of the weight of the lead powder; a weight of the deionized water was 9/o of the weight of the lead powder; a weight of the dilute sulfuric acid was 8% of the weight of the lead powder; a weight of the sodium perborate was 0.01% of the weight of the lead powder; and the lead powder accounted for the balance.

The dilute sulfuric acid had a density of 1.325 to 1.400 g/cm³; the lead powder had an oxidation degree of 72%; in the lead powder, iron, manganese, copper, and chlorine contents each were lower than 5 ppm and a bismuth content was lower than 40 ppm; and in the dilute sulfuric acid, an iron content was lower than 0.5 ppm and a chlorine content was lower than 5 ppm.

According to the above raw material ratio, the positive electrode lead paste for a long-life silicon-based bipolar lead battery was prepared by a method including the following steps:
S1. A graphite powder, 4PbO·PbSO₄, SnSO₄, Ti₄O₇, Sb₂O₃, sodium perborate, and a short fiber were added to a lead powder, and a resulting mixture was dry-stirred for 5 min until the above materials were evenly dispersed in the lead powder to obtain a premixture 1.
S2. Deionized water was rapidly added to the premixture 1, and a resulting mixture was thoroughly stirred for 10 min to obtain a premixture 2.
S3. Dilute sulfuric acid was slowly added to the premixture 2 within 10 min, where a temperature of a resulting mixture was 70° C., the resulting mixture was stirred for 10 min and then cooled to 50° C., and an apparent density was measured and controlled at 4.45±0.1 g/cm³.

### Example 2

A positive electrode lead paste for a long-life silicon-based bipolar lead battery was provided, where a formula of the positive electrode lead paste included the following components: a lead powder, a short fiber, a graphite powder, SnSO₄, Ti₄O₇, Sb₂O₃, 4PbO·PbSO₄, sodium perborate, dilute sulfuric acid, and deionized water, where a weight of the short fiber was 1.5% of a weight of the lead powder; a weight of the graphite powder was 5% of the weight of the lead powder; a weight of the Sb₂O₃ was 0.1% of the weight of the lead powder; a weight of the 4PbO·PbSO₄ was 1.5% of the weight of the lead powder; a weight of the SnSO₄ was 0.1% of the weight of the lead powder; a weight of the Ti₄O₇ was 0.3% of the weight of the lead powder; a weight of the deionized water was 11% of the weight of the lead powder; a weight of the dilute sulfuric acid was 12% of the weight of the lead powder; a weight of the sodium perborate was 0.03% of the weight of the lead powder; and the lead powder accounted for the balance.

The dilute sulfuric acid had a density of 1.325 to 1.400 g/cm³; the lead powder had an oxidation degree of 72%; in the lead powder, iron, manganese, copper, and chlorine contents each were lower than 5 ppm and a bismuth content was lower than 40 ppm; and in the dilute sulfuric acid, an iron content was lower than 0.5 ppm and a chlorine content was lower than 5 ppm.

According to the above raw material ratio, the positive electrode lead paste for a long-life silicon-based bipolar lead battery was prepared by a method including the following steps:
S1. A graphite powder, 4PbO·PbSO₄, SnSO₄, Ti₄O₇, Sb₂O₃, sodium perborate, and a short fiber were added to a lead powder, and a resulting mixture was dry-stirred for 5 min until the above materials were evenly dispersed in the lead powder to obtain a premixture 1.
S2. Deionized water was rapidly added to the premixture 1, and a resulting mixture was thoroughly stirred for 10 min to obtain a premixture 2.
S3. Dilute sulfuric acid was slowly added to the premixture 2 within 10 min, where a temperature of a resulting mixture was 70° C., the resulting mixture was stirred for 10 min and then cooled to 50° C., and an apparent density was measured and controlled at 4.45±0.1 g/cm³.

The lead paste prepared according to the above method was used in combination with a unique bipolar battery design structure to prepare a battery of a corresponding model through procedures such as curing, drying, encapsulation, assembly, and formation, and the battery was tested.

### Battery Test 1

The utilization of the active material in the 6V15 Ah long-life silicon-based bipolar lead battery prepared by the present disclosure was tested as follows:

In a 25° C. water bath, the battery was fully charged and then discharged to 1.75 V/cell with I20=0.75 A, a discharge time t1 was recorded, and the 20 h discharge capacity C20 and the 20 h active material utilization were calculated according to the design and actual use parameters. The data of 20 h utilization of the positive electrode active material were shown in Table 1.

TABLE 1

| | 20 h discharge | 20 h active |
|---|---|---|
| | time | material utilization |
| Formula of the | 24 h 3 min | 40.23% |
| present disclosure | | |
| Common formula | 22 h 24 min | 33.27% |

### Battery Test 2

The C2 cycling life of the 6V15 Ah long-life silicon-based bipolar lead battery prepared by the present disclosure was tested as follows:

In a 25° C. water bath, the battery was fully charged, then allowed to stand for 24 h, and discharged to 1.75 V/cell with C2=5 A, and a discharge time t2 and a discharge capacity were recorded; and when the discharge capacity was lower than 80% of a rated capacity, the test was stopped, and a discharge time and a discharge capacity were recorded. Comparative data of the cycling life were shown in the FIGURE and Table 2.

TABLE 2

| | Number of cycles |
|---|---|
| Formula of the present disclosure | 1004 |
| Common formula | 379 |

The above battery tests were conducted in accordance with the testing standards, and performance test results showed that the 20 h active material utilization was increased by 7% compared with the current common formula; and the C2 cycling life was directly increased by 2.6 times or more compared with the current common formula, indicating that the cycling life was significantly improved.

In summary, the long-life silicon-based bipolar lead battery with the positive electrode lead paste formula can improve the performance of the battery in various aspects and has high promotion and application values.

The above are merely preferred examples of the present disclosure, and not intended to limit the present disclosure. Any modifications, equivalent replacements, and improvements made within the spirit and principle of the present disclosure should fall within the protection scope of the present disclosure.

What is claimed is:

1. A positive electrode lead paste for a long-life silicon-based bipolar lead battery, wherein a formula of the positive electrode lead paste for the long-life silicon-based bipolar lead battery comprises components of: a lead powder, a short fiber, a graphite powder, SnSO₄, Ti₄O₇, Sb₂O₃, 4PbO·PbSO₄, sodium perborate, dilute sulfuric acid, and deionized water.

2. The positive electrode lead paste for the long-life silicon-based bipolar lead battery according to claim 1, wherein the components in the formula of the positive electrode lead paste for the long-life silicon-based bipolar lead battery are used at amounts as follows: a weight of the short fiber is 0.5% to 1.5% of a weight of the lead powder; a weight of the graphite powder is 2% to 5% of the weight of the lead powder; a weight of the Sb₂O is 0.03% to 0.1% of the weight of the lead powder; a weight of the 4PbO·PbSO₄ is 0.5% to 1.5% of the weight of the lead powder; a weight of the SnSO₄ is 0.03% to 0.1% of the weight of the lead powder; a weight of the Ti₄O₇ is 0.1% to 0.3% of the weight of the lead powder; a weight of the deionized water is 9% to 11% of the weight of the lead powder; a weight of the dilute sulfuric acid is 8% to 12% of the weight of the lead powder; a weight of the sodium perborate is 0.01% to 0.05% of the weight of the lead powder; and the lead powder accounts for the balance.

3. The positive electrode lead paste for the long-life silicon-based bipolar lead battery according to claim 2, wherein the dilute sulfuric acid has a density of (1.325-1.400)±0.003 g/cm³.

4. The positive electrode lead paste for the long-life silicon-based bipolar lead battery according to claim 2, wherein the lead powder has an oxidation degree of 72% to 80%, and in the lead powder, iron, manganese, copper, and chlorine contents each are lower than 5 ppm and a bismuth content is lower than 40 ppm.

5. The positive electrode lead paste for the long-life silicon-based bipolar lead battery according to claim 2, wherein in the dilute sulfuric acid, an iron content is lower than 0.5 ppm and a chlorine content is lower than 5 ppm.

6. A preparation method of a positive electrode lead paste for a long-life silicon-based bipolar lead battery, comprising the following steps:
S1, adding a graphite powder, 4PbO·PbSO₄, SnSO₄, Ti₄O₇, Sb₂O₃, sodium perborate, and a short fiber to a lead powder according to a formula ratio to obtain a first resulting mixture, and dry-stirring the first resulting mixture for 4 min to 7 min until the graphite powder, the 4PbO·PbSO₄, the SnSO₄, the Ti₄O₇, the Sb₂O₃, the sodium perborate, and the short fiber are evenly dispersed in the lead powder to obtain a first premixture;
S2, rapidly adding deionized water to the first premixture to obtain a second resulting mixture, and thoroughly stirring the second resulting mixture for 8 min to 13 min to obtain a second premixture; and
S3, slowly adding dilute sulfuric acid with a density of (1.325-1.400)±0.003 g/cm³ to the second premixture within 10 min to 15 min to obtain a third resulting mixture, and stirring the third resulting mixture for 5 min to 10 min; and cooling the third resulting mixture to 50° C., measuring an apparent density of the third resulting mixture, and controlling the apparent density at 4.45±0.1 g/cm³.

7. The preparation method of the positive electrode lead paste for the long-life silicon-based bipolar lead battery according to claim 6, wherein in S3, the second premixture and the dilute sulfuric acid are mixed at a temperature controlled at 65° C. to 75° C.

8. The preparation method of the positive electrode lead paste for the long-life silicon-based bipolar lead battery according to claim 6, wherein a weight ratio of the lead powder, the short fiber, the graphite powder, the SnSO₄, the Ti₄O₇, the Sb₂O₃, the 4PbO·PbSO₄, the sodium perborate, the dilute sulfuric acid, and the deionized water is as follows: a weight of the short fiber is 0.5% to 1.5% of a weight of the lead powder; a weight of the graphite powder is 2% to 5% of the weight of the lead powder; a weight of the Sb₂O₃ is 0.03% to 0.1% of the weight of the lead powder; a weight of the 4PbO·PbSO₄ is 0.5% to 1.5% of the weight of the lead powder; a weight of the SnSO₄ is 0.03% to 0.1% of the weight of the lead powder; a weight of the Ti₄O₇ is 0.1% to 0.3% of the weight of the lead powder; a weight of the deionized water is 9% to 11% of the weight of the lead powder; a weight of the dilute sulfuric acid is 8% to 12% of the weight of the lead powder; a weight of the sodium perborate is 0.01% to 0.05% of the weight of the lead powder; and the lead powder accounts for the balance.

9. The preparation method of the positive electrode lead paste for the long-life silicon-based bipolar lead battery according to claim 6, wherein the lead powder has an oxidation degree of 72% to 80%; in the lead powder, iron, manganese, copper, and chlorine contents each are lower than 5 ppm and a bismuth content is lower than 40 ppm; and in the dilute sulfuric acid, an iron content is lower than 0.5 ppm and a chlorine content is lower than 5 ppm.
